(19) United States
(12) Patent Application Publication
(10) Pub. No.: US 2016/0089676 A1
(43) Pub. Date: Mar. 31, 2016

(54) Comminuting machine for waste material

(71) Applicant: FOR REC SRL, SANTA GIUSTINA IN COLLE (PD) (IT)

(72) Inventor: PIERANGELO TONDELLI, SANTA GIUSTINA IN COLLE (PD) (IT)

(21) Appl. No.: 14/864,867

(22) Filed: Sep. 25, 2015

(30) Foreign Application Priority Data
Sep. 25, 2014 (IT) TV2014A000142

(51) Int. Cl. B02C 18/18; B02C 18/14

(52) U.S. Cl. CPC B02C 18/18; B02C 18/145; B02C 2018/188; B02C 2018/162

(57) ABSTRACT

A comminuting machine (MC) for waste material is described. It comprises a frame comprising a cutting table (60) equipped with fixed knives (22, 24), a shaft (30b, 30b) rotatably mounted in the frame and on the table, and equipped with an array of rotating blades (20a, 20b) radially projecting from the shaft. The rotating knives to cut the material have a face adjacent to, and adapted to cooperate with, a fixed knife.

To improve the machine the frame comprises a housing (AL) for the table, the table being insertable and removable from in said housing independently from the shaft and the rest of the frame.

The invention relates in general to a comminuting machine, e.g. for waste materials such as scraps, residues, or waste or recyclable materials.

A machine of this type is described in EP 0 521 081. It comprises two rotating shafts equipped with an array of knives radially placed along the axis at a constant distance from each other. The material to be ground is hooked by the rotary knife and sliced against fixed knives installed on a table. The comminuted pieces fall by gravity and are then collected under the table.

The fixed blades of the table must be replaced when they wear out or when a different size of the grinding is needed (which is obtained by varying the size of the fixed and rotating knives).

In known machines the replacement is very long, complex and expensive, because the fixed knifes are integrated in the frame of the machine and it must be, in practice, disassembled completely.

It is desired to improve this state of the art, in particular with a comminuting machine simpler to build, more particularly wherein the substitution of fixed knives, and/or the table on which they are mounted, is simpler and less expensive.

To this aim, it is proposed a comminuting machine for waste material comprising:

frame comprising:
a cutting table equipped with fixed knives,
a shaft rotatably mounted in the frame and on the table, and equipped with an array of rotating blades radially projecting from the shaft,
wherein the rotating knives to cut the material have a face adjacent to, and adapted to cooperate with, a fixed knife,

wherein the frame comprises a housing for the table, preferably with a shape complementary to the shaping of the table, and the table is (configured so as to be) insertable in and removable from said housing independently from the shaft and the rest of the frame.

Being removed the constraint of a table fixed to the frame, its replacement and maintenance is greatly simplified.

The housing, as already suggested above, can have different configurations. E.g. the housing comprises a cavity in the frame that

is a pass-through cavity,

comprises vertical walls and

is adapted to receive at its inlet material to be comminuted and to eject the comminuted material.

To better integrate the shafts into the frame, the frame may comprise a body, e.g. anular, comprising walls which delimit said housing or cavity, two opposite walls of which are adapted to rotatably support the shaft.

One can move the table manually or, more conveniently, by a drive unit mounted on the comminuting machine arranged to move, e.g. translate, the table relative to the housing and adapted to make it come in or out from it. in general, any type of movement is employable to get the table near/away to/from the housing.

To simplify the machine, one can use a support for the table, the support being translatable by the drive unit towards and away from the housing. Such support can take many forms, and preferably it is provided with pass-through openings for the passing of the comminuted material. Thus the material does not accumulate on it and the drive unit does not go under stress because of the weight of the material.

Among the various types of possible drive units, a linear actuator is advantageous, connected between the frame and the support, and adapted to move the support So the space available under the rotary shafts is exploited, and the table can also be moved down to the ground when it is removed from the housing.

About the structure of the table, to make it robust and easy to produce, it may comprise a box-shaped frame, e.g. a parallelepiped frame with a square or rectangular base, with side walls delimiting a pass-through cavity in which the fixed knives are mounted. Inside the cavity of the table an array of metal sheets or baffles can be present, on top of which are placed, e.g. lying on the same plane, the fixed knives. One or each metal sheet or baffle may form an acute angle, relative to the wall of the table from which it extends, which is preferably comprised between 89 degrees and 45 degrees.

Preferably each metal sheet comprises a recess for a shaft, wherein the recesses of each metal sheet are aligned with one another and equal to those of the adjacent metal sheets.

The following description relates to a preferred embodiment of comminuting machine and will highlight further advantages of its, with reference to the accompanying drawings in which:

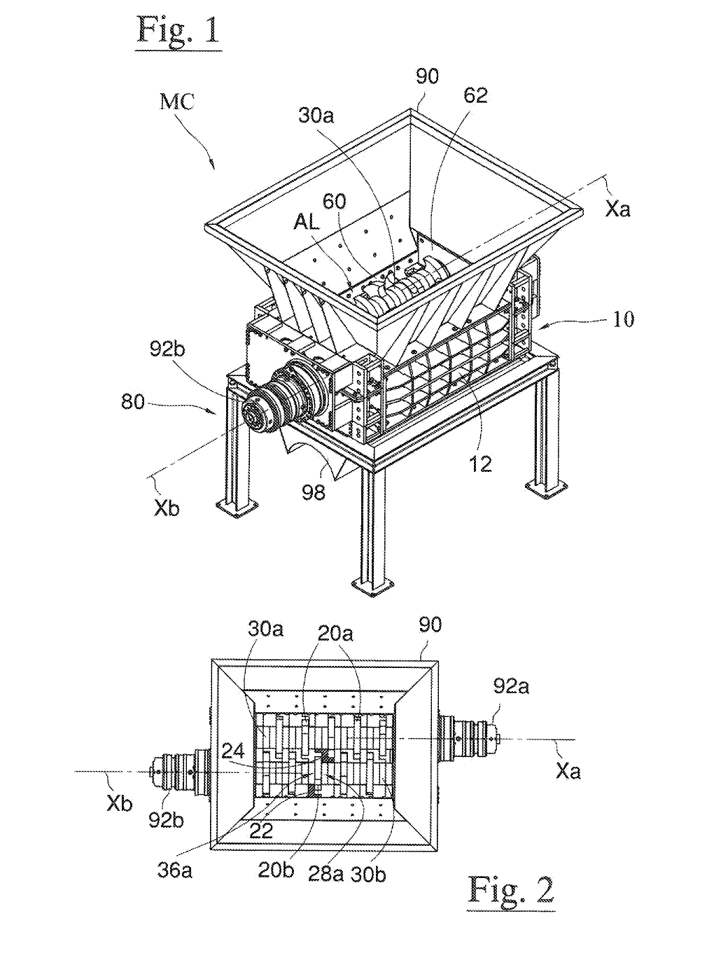

FIG. 1 shows a three dimensional view of a comminuting machine;

FIG. 2 shows a top view of the comminuting machine of FIG. 1;

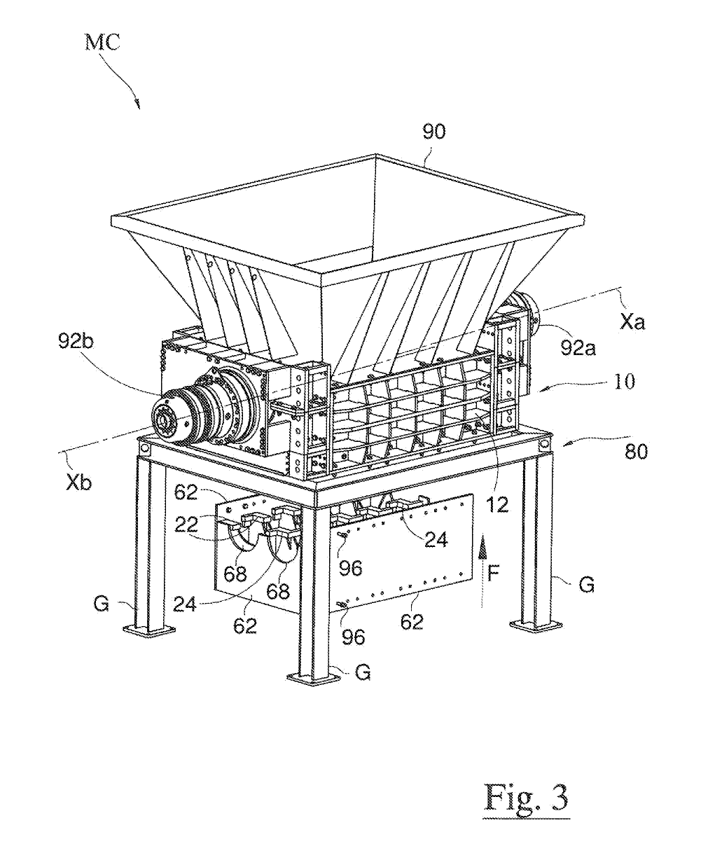

FIG. 3 shows the comminuting machine of FIG. 1 with a component removed;

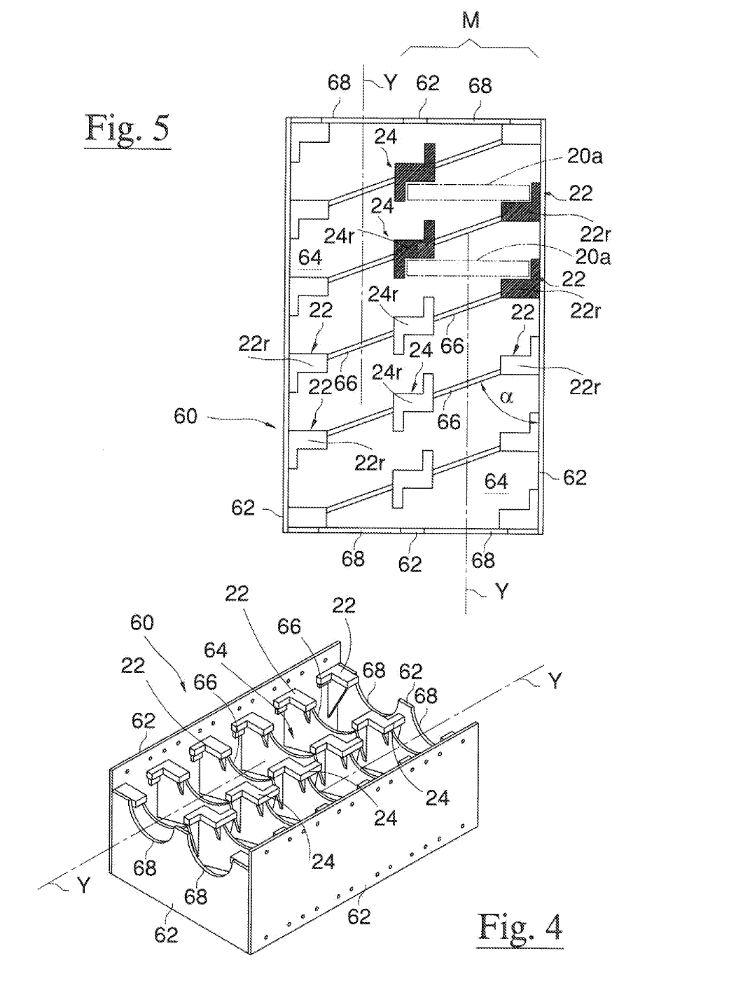

FIG. 4 shows a three dimensional view of a table for fixed knives of the comminuting machine in FIG. 1;

FIG. 5 shows a top view of the table of FIG. 4;

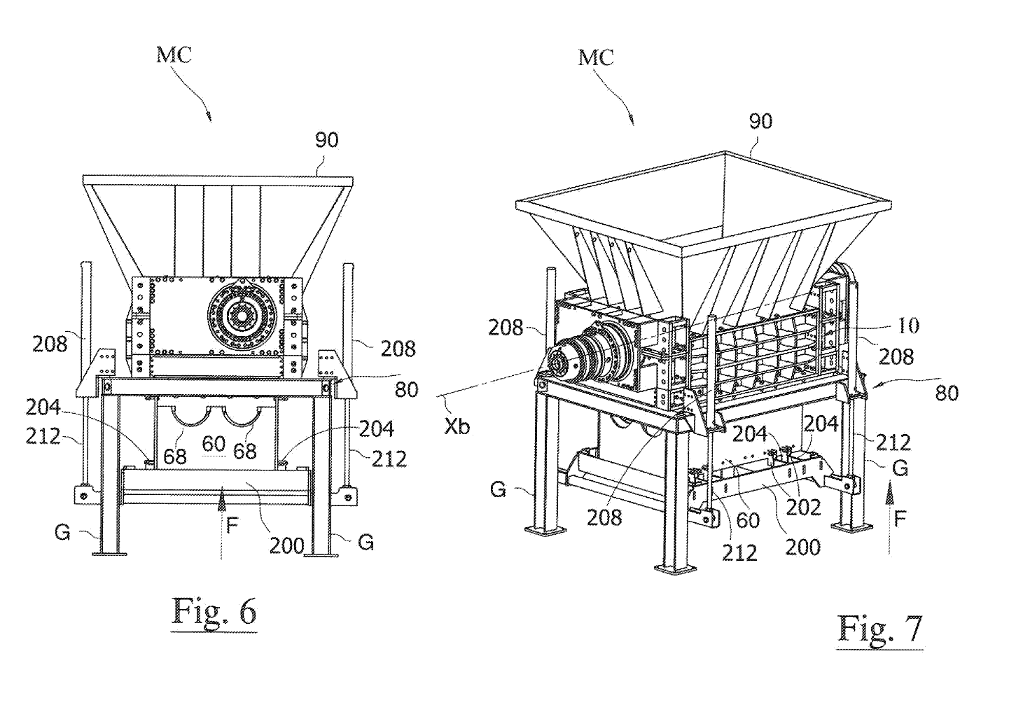

FIGS. 6 and 7 show a variant of the comminuting machine.

In the figures same numerals indicate same or similar parts, and the comminuting machine is described as being in use. The numbers for simplicity indicate only some components so as not to crowd the drawings.

A comminuting machine MC is formed (FIG. 1) by a supporting frame 80, with e.g. four vertical legs G for resting on the ground that delimit an empty space, a shredding assembly 10 and a hopper 90 to feed material into the group 10.

The assembly 10 comprises an outer body 12, e.g. finned, which is centrally hollow for forming a housing AL for a table 60. Two opposite walls of the body 12 rotatably support two shafts 30a, 30b, with parallel axes respectively designated Xa, Xb, and connected with two heads 92a, 92b external to the body 12. The shafts 30a, 30b horizontally cross the cavity, open above and below, of the body 12. In the following we will use the suffixes “a” and “b” for components respectively related to the two shafts 30a, 30b while often it will be sufficient to describe the system for the single shaft 30a.

The shaft 30a is equipped with various knives 20a integrally arranged along the axis Xa and spaced apart by a certain distance. The knives 20a have known form, e.g. like a disk, a spoke or a hammer, and exhibit two opposite faces 36a, 28a, substantially parallel to one another and preferably nearly orthogonal or orthogonal to the axis Xa, which delimit their thicknesses along the axis Xa.

Inside the body 12, in particular inside the housing AL, is mountable in removable manner a structure or table 60 (FIGS. 4 and 5) which supports the fixed knives 22, 24 which cooperate with the knives 20a, 20b.

Therefore, the material is loaded into the hopper 90, falls over the shafts 30a, 30b, is comminuted inside the cavity of the body 12 and is unloaded by gravity by a funnel 98 placed under the body 12.

The table 60 is a body fixable and/or fixed inside the cavity or housing AL of the body 12, e.g. by means of screws 96 or other fastening means, and is detachable from it leaving the rest of the comminuting machine MC intact. FIG. 3 shows as an example the table 60 disassembled from the group 10, to which it can be re-applied or replaced with a new or different one, e.g. from below, by removing the funnel 98 (which is optional). In order to facilitate removal and to avoid empty spaces the material can clog, the central cavity or housing AL of the body 12 is complementary to the plan of the table 60, thus it is enough to insert from below the table 60 (direction F) into the body 12 and fasten it there to render the machine MC operative.

Note that, to change the fixed knives, advantageously it is not necessary to dismount or alter or replace the structure that rotatably supports the shafts 20a, 20b, e.g. the body 12, and the shafts 20a, 20b themselves neither, with huge savings of time money and material. When the fixed knives wear out one just extracts the table 60 and replace and/or regenerate it with a new one the same being true if one wants to change the shape or type of the fixed knives.

FIGS. 6 and 7 show the comminuting machine MC when provided with means for moving the table 60 inside the group 10 or removing it from the latter.

The means comprise a movable support 200, which is fixed on the table 60 by means of e.g. hooks or clamps 202. To lighten the structure, ease installation of the table 60 and allow a smooth passage of the shredded material, the support 200 is preferably formed by an outer frame 206 that supports at the center spaced-apart vertical plates 204, which form a sort of grid. The plates 204 let the shredded material pass through and can be used as anchorage for the hooks 202.

The support 200 is coupled to linear drives, e.g. four hydraulic pistons 208 with movable sterns 212, mounted by means of flanges on the group 10.

By activating the linear drives one can raise or lower the table 60 with respect to the group 10, and then insert or remove it from its housing AL inside the group 10.

An advantage of a translatable support for the table 60 is also to allow unlocking automatically and/or easily the comminuting machine in the ease material clogs between the shafts 20a, 20b and the table 60. One can then perform a cycle of lifting-lowering the support 200, or in general remove and replace the table 60 from/into the group 10.

Advantageously, the table 60 has a box-shaped frame, e.g. parallelepiped or frusto-piramydal with a square or rectangular base, with side walls 62 that delimit a pass-through cavity 64. Inside the cavity 64 is a plurality or array of metal sheets or baffles 66 on the top of which are located, lying in the same plane, the fixed knives 22, 24. Each metal sheet 66 comprises two lodgments 68 for a shaft, in the form e.g. of a semicircular recess. The lodgments 68 of each metal sheet 66 are aligned with one another and equal to those of the adjacent metal sheets 66, so that they altogether form a concave seat along an imaginary axis Y in which to lay the shaft (whose axis Xa, Xb, will be parallel to, and can be coincident with, the axis Y).

With reference to FIGS. 4 and 5, the arrangement of the knives 22, 24 can be seen (better shown by darkening some with a hatch). Around each knife 20a, shown schematically in FIGS. 4 and 5 with hatching, there are two fixed knives 22, 24. The knife 22 has L-shaped plan, lies on the perimeter of the table 60 and is adjacent to the face 28a, while the knife 24 has Z-shaped plan, is adjacent to the face 26a and is at the center of the table 60. The knives 22, 24 thus have a rectilinear segment 22r, 24r, and are arranged so that such segment 22r, 24r is orthogonal to the axis Xa of the shaft 30a. The distance between the segments 22r, 24r of two fixed knives 22, 24 adjacent to a same knife 20a is about the thickness of the knife 20a itself.

Also note that a knife 24 is common to the two blades 20a, 20b.

The arrangement of the fixed knives 22, 24, in which the segments 22r, 24r are not necessarily aligned orthogonally to the axes Xa, Xb, is advantageously obtained in a simple way by means of the inclination of the metal sheets 66 with respect to such axes and/or to two parallel walls 62 (FIG. 5).

Each metal sheet 66 supports a fixed knife 22, 24 adjacent to, and cooperating with, at least two different knives 20a of the same shaft. In particular, each metal sheet 66 supports at least the fixed knives relative to the directly-facing faces 36a, 28a of two consecutive, different knives 20a.

Another advantage is that the inclination of the metal sheets 66 also applies with respect to the fixed knives 22, 24, which are therefore supported by a larger section of a metal sheet 66, Thus one can support larger fixed knives (or with greater blade), the size of the table 60 or the thickness of the metal sheet 66 being equal.

The inclined metal sheets 66 can also be used, however, with fixed knives of known arrangements.

The acute angle α formed by a metal sheet 66 relative to the wall 62 from which it extends (FIG. 5) can vary between 89 degrees and 45 degrees, preferably between 75 degrees and 45 degrees, even more preferably being 60 degrees.

Variants

The machine MC or the one defined in general, also in the claims, can have many variants, to be used alone or in combination with each other and/or with what has already been described. E.g. there can be

a different number of rotating shafts and/or rotating knives. Note the possible modular construction of the table 60 for each shaft (module M shown in FIG. 5): to house more/less shafts one just lengthens/shortens the walls 62 and the metal sheets 66, and adds/removes fixed blades 22, 24, and adds/removes lodgments 68;

or one can juxtapose several tables 60 wherein each realizes a module M for a single shaft or a module to house n-shafts. Let in be the total number of shafts in the comminuting machine, k tables can be mounted juxtaposed so that m=n1+n2+ . . . +nk where ni is the number of shafts housed by the i-th table; and/or

different shapes for the fixed knives in the table 60; e.g. linear without contrast on the tangent of the blade, oval-shaped in order to have a point tangent to the blade and a progressive cut, or diamond-shaped in order to have a progressive cut; and/or

different inclinations for the metal sheets 66, for example. not all with the same inclination; and/or

different shapes for the lodgments 68, which are also optional; and/or

one can insert an upper abutment between the table 60 (at the top of the latter) and the machine body such as to prevent the passage of dust within this space and restrict consequent pinching of the table itself; and/or

means, for moving the table 60 with respect to the seat or housing AL in the group 10, different from those described in FIGS. 6 and 7: e.g. actuators of a different type, such as an electric motor, or an actuator, such as a jack, mounted in different parts of the machine, e.g. at the feet of the machine. The table 60 would be supported in this case from below and not suspended as in FIG. 6. Or one can use if necessary an hydraulic jack or a forklift.

1. Comminuting machine (MC) for waste material comprising
a frame comprising
a cutting table (60) equipped with fixed knives (22, 24),
a shaft (30a, 30b) rotatably mounted in the flame and on the table, and equipped
with an array of rotating blades (20a, 20b) radially projecting from the shaft,
wherein the rotating knives to cut the material have a face adjacent to, and adapted to cooperate with, a fixed knife,
the frame comprising a housing (AL) for the table, the table being insertable into and removable from said housing independently from the shaft and the rest of the frame.

2. Machine according to claim 1, wherein the housing comprises a cavity in the frame that: is a pass-through cavity, comprises vertical walls and is adapted to receive at the inlet material to be comminuted and to eject the comminuted material.

3. Machine according to claim 1 or 2, wherein the frame comprises a body (12) comprising walls which delimit said housing and two opposite walls of which are adapted to rotatably support the shaft.

4. Machine according to any one of the preceding claims, comprising a drive unit (208) arranged to move the table relative to the housing and make the table come in or out of it.

5. Machine according to claim 4, comprising a support (200) for the table, the support being movable by the drive unit toward and from the housing.

6. Machine according to claim 4 or 5, wherein the support is provided with pass-through openings for the passing of the comminuted material.

7. Machine according to claim 5 or 6, comprising a linear actuator (208), connected between the frame and the support, adapted to move the support.

8. Machine according to any one of the preceding claims, wherein the table comprises a box-shaped frame, e.g. a parallelepiped frame with a square or rectangular base, with side walls (62) delimiting a pass-through cavity in which the fixed knives are mounted.

9. Machine according to claim 8, wherein inside the cavity of the table there is an array of metal sheets or baffles (66) on top of which the fixed knives are placed.

10. Machine according to claim 9, wherein a metal sheet or baffle forms an acute angle (α), relative to the wall of the table from which it extends, that is between 89 degrees and 45 degrees.

11. Machine according to claim 9 or 10, wherein each metal sheet comprises a recess for a shaft, wherein the recesses of each metal sheet are aligned with one another and equal to those of the adjacent metal sheets.
